(19) United States
(12) Patent Application Publication
(10) Pub. No.: US 2006/0109375 A1
(43) Pub. Date: May 25, 2006

(54) All-directional camera viewfinder angle adjusting mechanism

(76) Inventors: Hsin-Chiang Ho, Taipei (TW); Yi-Min Tseng, Taipei (TW)

Correspondence Address: Mr. Joseph A. Sawyer, Jr.;SAWYER LAW GROUP LLP, Embarcadero Corporate Center, Suite 406, 2465 East Bayshore Road, Palo Alto, CA, 94303, US

(21) Appl. No.: 10/996,932

(22) Filed: Nov. 23, 2004

(51) Int. Cl. H04N 5/225; G03B 17/00

(52) U.S. Cl. 348/376; 396/428; D16/214

(57) ABSTRACT

An all-directional camera viewfinder angle adjusting mechanism is proposed, which is designed for use in conjunction with a photographic device for the purpose of allowing the user to arbitrarily adjust the viewfinder angle of the photographic device to any directions within 360° full-angle range both horizontally and vertically so as to aim the photographic device precisely at the target object that is to be photographed. Compared to prior art, the proposed all-directional camera viewfinder angle adjusting mechanism allows the user to precisely adjust the viewfinder angle of a Web camera to any desired directions so that there will be no dead spots in the scene that is to be photographed, and is therefore more advantageous to use than prior art.

### BACKGROUND OF THE INVENTION

1. Field of the Invention

This invention relates to camera technology, and more particularly, to an all-directional camera viewfinder angle adjusting mechanism which is designed for use in conjunction with a photographic device, such as a Web camera, for the purpose of allowing the user to arbitrarily adjust the Web camera's viewfinder angle to any desired directions so as to aim the Web camera's viewfinder precisely at the target object that is to be photographed.

2. Description of Related Art

Web camera is a digital image capturing device that is capable of capturing still or motion images (i.e., video images) in digital form and is capable of being linked to a computer platform, such as a desktop computer, a notebook computer, a network workstation, or the like, for processing and transferring the captured images via a network system, such as an LAN (Local Area Network) system or the Internet, to a remote computer platform, for the user at the remote site to view the captured images. Web camera applications include, for example, online video conference, online chat, security monitoring, live broadcast, to name just a few.

In practical application, when a Web camera has been installed in position at a certain place, the user often needs to adjust the viewfinder angle of the Web camera so as to aim it directly at the target object that is to be photographed.

One drawback to present Web cameras on the market, however, is that they are typically capable of allowing the user to adjust the viewfinder angle horizontally in full-angle range (i.e., 360°), but only a limited angular range (typically only about 30°) in the vertical direction. This limitation restricts the user from arbitrarily adjusting the viewfinder angle of the Web camera to any desired directions, thus undesirably resulting in some dead spots in the scene that is to be photographed.

### SUMMARY OF THE INVENTION

It is therefore an objective of this invention to provide an all-directional camera viewfinder angle adjusting mechanism for use with a Web camera or the like to allow the Web camera to be rotatable in full-angle 360° range both horizontally or vertically, so as to allow the user to aim the viewfinder angle of the Web camera arbitrarily at any desired directions.

The all-directional camera viewfinder angle adjusting mechanism according to the invention is designed for use in conjunction with a photographic device, such as a Web camera, for the purpose of allowing the user to arbitrarily adjust the viewfinder angle of the photographic device to any directions within 360° full-angle range both horizontally and vertically so as to aim the photographic device precisely at the target object that is to be photographed.

Compared to prior art, the all-directional camera viewfinder angle adjusting mechanism of the invention allows the user to precisely adjust the viewfinder angle of a Web camera to any desired directions so that there will be no dead spots in the scene that is to be photographed, and is therefore more advantageous to use than the prior art.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing an exploded perspective view of the all-directional camera viewfinder angle adjusting mechanism of the invention and a Web camera;

FIG. 2 is a schematic diagram showing a sectional side view of the combined body of the Web camera and the all-directional camera viewfinder angle adjusting mechanism of the invention shown in FIG. 1;

FIG. 3A is a schematic diagram used to depict how the all-directional camera viewfinder angle adjusting mechanism of the invention is capable of horizontally adjusting the viewfinder angle of the Web camera; and

FIG. 3B is a schematic diagram used to depict how the all-directional camera viewfinder angle adjusting mechanism of the invention is capable of vertically adjusting the viewfinder angle of the Web camera.

### DETAILED DESCRIPTION OF PREFERRED EMBODIMENTS

The all-directional camera viewfinder angle adjusting mechanism according to the invention is disclosed in full details by way of preferred embodiments in the following with reference to the accompanying drawings.

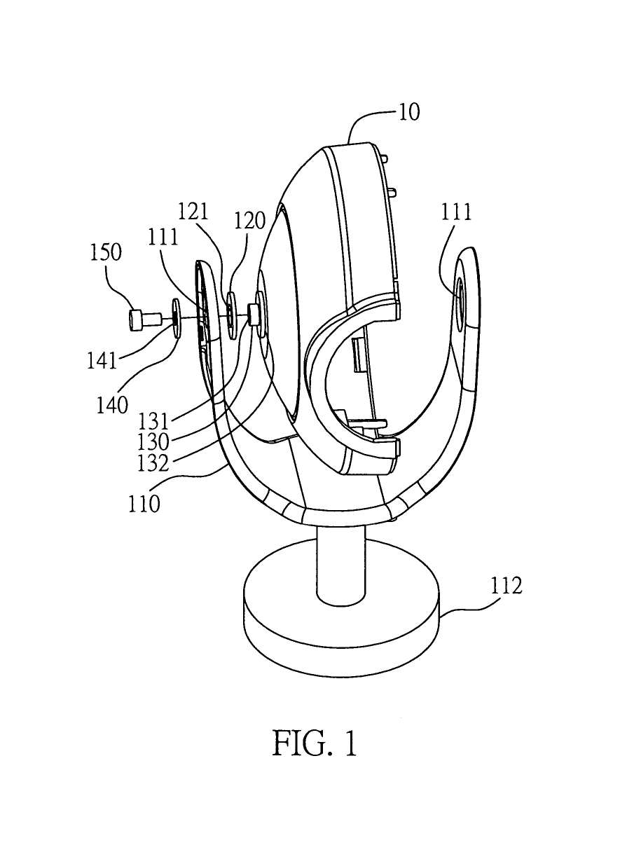

FIG. 1 is a schematic diagram showing an exploded perspective view of the all-directional camera viewfinder angle adjusting mechanism of the invention and a photographic device 10, such as a Web camera (note that in FIG. 1, only a half part of the Web camera is shown). In practical application, for instance, the photographic device 10 can be either a Web camera or a security monitor camera. Functionally, the all-directional camera viewfinder angle adjusting mechanism of the invention is designed for the purpose of allowing the user to arbitrarily adjust the viewfinder angle of the photographic device 10, either vertically or horizontally, to any directions so as to aim the photographic device 10 precisely at the target object that is to be photographed.

As shown in FIG. 1, the all-directional camera viewfinder angle adjusting mechanism of the invention comprises: (a) a supporting frame 110; (b) a rotating-shaft washer 120; (c) a rotating shaft 130; (d) a bolt washer 140; and (e) a threaded bolt 150.

The supporting frame 110 is substantially a U-shaped member whose two free ends are respectively formed with at least one bearing hole 111 whose inner diameter is compatible with the outer diameter of the rotating shaft 130 so as to allow the rotating shaft 130 to be insertable into the bearing hole 111. In addition, the supporting frame 110 can be optionally linked to a rotatable base 112 so as to allow the supporting frame 110 to be rotatable on the rotatable base 112 in a full 360□angular range. In other embodiment, a non-rotatable base can be used in replace of the rotatable base 112.

The rotating-shaft washer 120 is made of a flexible material with a high surface resistance, such as rubber or silicone, and which is formed with a perforation 121 in the center thereof, with the inner diameter of the perforation 121 being compatible with the outer diameter of the rotating shaft 130 so as to allow the rotating shaft 130 to be penetrable through the perforation 121.

The rotating shaft 130 is an elongated bar having one end formed with a disk portion 132 and fixed to the photographic device 10, and the other end being a free end formed in the axial direction with a threaded hole 131. In size specification, the rotating shaft 130 should has its outer diameter compatible with the inner diameter of the perforation 121 in the rotating-shaft washer 120 so as to allow the rotating shaft 130 to be penetrable through the perforation 121 of the rotating-shaft washer 120 for insertion into the bearing hole 111; and the threaded hole 131 should has its inner diameter compatible with the outer diameter of the threaded bolt 150 so as to allow the threaded bolt 150 to be screwable into the threaded hole 131. Moreover, the disk portion 132 preferably has its diameter substantially equal to the diameter of the rotating-shaft washer 120.

The bolt washer 140 is made of a flexible material, such as rubber or silicone, and which is formed in the center thereof with a perforation 141 whose inner diameter is compatible with the outer diameter of the threaded bolt 150 so as to allow the threaded bolt 150 to be penetrable through the perforation 141.

The threaded bolt 150 has its outer diameter compatible with the inner diameter of the perforation 141 of the bolt washer 140 so as to allow the threaded bolt 150 to be penetrable through the perforation 141 of the bolt washer 140 for engagement with the threaded hole 131 in the free end of the rotating shaft 130.

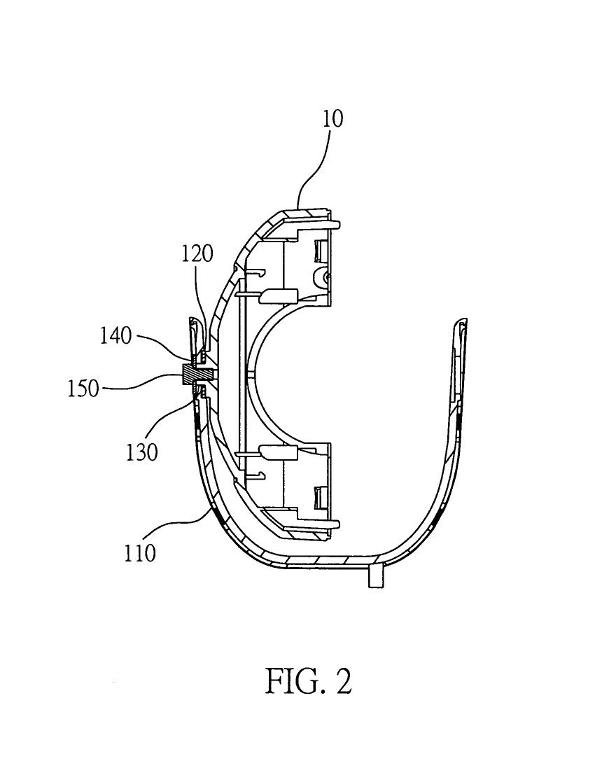

Referring to FIG. 1 together with FIG. 2, during assembly, the first step is to penetrate the rotating shaft 130 through the perforation 121 of the rotating-shaft washer 120 so as to be inserted into the bearing hole 111 and allow the disk portion 132 to forcibly come in touch with the rotating-shaft washer 120. Next, the threaded bolt 150 is inserted through the perforation 141 of the bolt washer 140 so as to be engaged with the threaded hole 131 in the free end of the rotating shaft 130. This results in the photographic device 10 being rotatably mounted to the bearing hole 111 in the supporting frame 110, with the disk portion 132 being forcibly attached to the rotating-shaft washer 120. When the photographic device 10 is subjected to a pushing force (i.e., from the user's hand) that rotates it in the vertical direction, it allows the photographic device 10 to be rotated angularly about the rotating shaft 130 within 360° full-angle range. During this rotational adjustment, since the disk portion 132 of the rotating shaft 130 is forcefully attached to the rotating-shaft washer 120 which is flexible and has a high-surface resistance, it allows the photographic device 10 to be firmly secured in position when rotated to any angle.

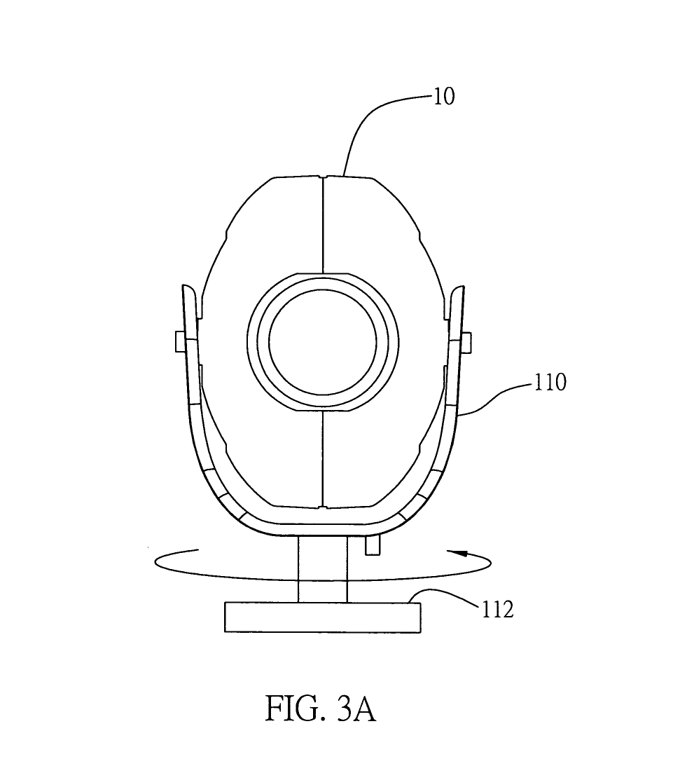

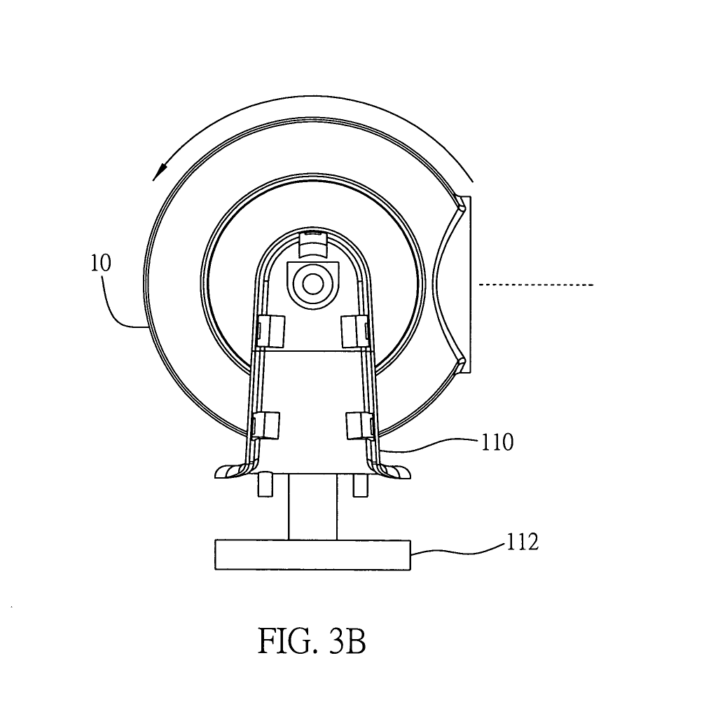

FIG. 3A is a schematic diagram used to depict how the all-directional camera viewfinder angle adjusting mechanism of the invention is capable of horizontally adjusting the viewfinder angle of the photographic device 10. As shown, since the supporting frame 110 is linked to a rotatable base 112, it allows the user to adjust the viewfinder angle of the photographic device 10 by turning the supporting frame 110 on the rotatable base 112 within 360° full-angle range. If the rotatable base 112 is replaced by a non-rotatable base, the user nevertheless can adjust the viewfinder angle of the photographic device 10 simply by changing the orientation of the non-rotatable base on a desktop.

FIG. 3B is a schematic diagram used to depict how the all-directional camera viewfinder angle adjusting mechanism of the invention is capable of vertically adjusting the viewfinder angle of the photographic device 10. As shown, when the user wants to vertically elevate the viewfinder angle of the photographic device 10 to a higher angle, the user needs just to manually turn the photographic device 10 about the rotating shaft 130 to position the viewfinder angle in the desired direction. During this rotational adjustment, since the rotating shaft 130 is forcefully attached to the rotating-shaft washer 120 which is flexible and has a high-surface resistance, it allows the photographic device 10 to be firmly secured in position at the newly-adjusted angle.

In conclusion, the invention provides an all-directional camera viewfinder angle adjusting mechanism which is designed for use in conjunction with a photographic device for the purpose of allowing the user to arbitrarily adjust the viewfinder angle of the photographic device to any directions within 360° full-angle range both horizontally and vertically so as to aim the photographic device precisely at the target object that is to be photographed. Compared to prior art, the invention allows the user to precisely adjust the viewfinder angle of a Web camera to any desired directions so that there will be no dead spots in the scene that is to be photographed. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. An all-directional camera viewfinder angle adjusting mechanism for use with a photographic device for providing the photographic device with a manually-adjustable capability for manually adjusting the photographic device to any desired viewfinder angle;
the all-directional camera viewfinder angle adjusting mechanism comprising:
a supporting frame, which is formed with at least one bearing hole;
a rotating-shaft washer, which is formed with a perforation in the center thereof, and which is used for attaching to a first side of the bearing hole;
a rotating shaft, which has one end is formed with a disk portion and fixed to the photographic device, and another end formed with a threaded hole and used for insertion through the perforation in the rotating-shaft washer and through the bearing hole in the supporting frame;
a bolt washer, which is formed with a perforation in the center thereof and used for axially attaching to a second side of the bearing hole; and
a threaded bolt, which is used for penetrating through the perforation in the bolt washer and the bearing hole in the supporting frame to be engaged with the threaded hole in the rotating shaft for mounting the photographic device onto the supporting frame and meanwhile causing the disk portion of the rotating shaft to be attached on the rotating-shaft washer to allow the photographic device to be angularly adjustable within 360° full-angle range about the rotating shaft.

2. The all-directional camera viewfinder angle adjusting mechanism of claim 1, wherein the photographic device is a Web camera.

3. The all-directional camera viewfinder angle adjusting mechanism of claim 1, wherein the photographic device is a security monitor camera.

4. The all-directional camera viewfinder angle adjusting mechanism of claim 1, wherein the rotating-shaft washer is made of a flexible material.

5. The all-directional camera viewfinder angle adjusting mechanism of claim 4, wherein the flexible material is selected from the group comprising rubber and silicone.

6. The all-directional camera viewfinder angle adjusting mechanism of claim 1, wherein the bolt washer is made of a flexible material.

7. The all-directional camera viewfinder angle adjusting mechanism of claim 6, wherein the flexible material is selected from the group comprising rubber and silicone.

8. The all-directional camera viewfinder angle adjusting mechanism of claim 1, wherein the supporting frame is linked to a rotatable base so as to allow the supporting frame to be rotatable within 360° full-angle range on the rotatable base.

9. The all-directional camera viewfinder angle adjusting mechanism of claim 1, wherein the supporting frame is linked to a non-rotatable base.
